(19) United States
(12) Patent Application Publication
(10) Pub. No.: US 2007/0054619 A1
(43) Pub. Date: Mar. 8, 2007

(54) Method and arrangement for radio resource control

(75) Inventors: Pasi Kinnunen, Oulu (FI); Jaakko Vihriala, Oulu (FI); Kari Horneman, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: NOKIA CORPORATION

(21) Appl. No.: 11/270,637

(22) Filed: Nov. 10, 2005

(30) Foreign Application Priority Data
Sep. 2, 2005 (FI) 20055469

(51) Int. Cl. H04B 1/00

(52) U.S. Cl. 455/63.1; 455/67.13; 455/560

(57) ABSTRACT

The invention relates to a radio network, comprising means for receiving an uplink signal from a user using the radio network, means for performing interference cancellation on the received uplink signal, means for estimating a load factor for the received uplink signal, the load factor indicating the load the uplink signal causes on a network element of the radio network, wherein the load factor is estimated by taking into consideration the interference cancellation performed on the received uplink signal, and means for using the estimated load factor when allocating radio resources in the radio network.

### FIELD

The invention relates to a method and arrangement of controlling radio resources in a radio network.

### BACKGROUND

Radio network planning includes several tasks, such as dimensioning and capacity and coverage planning of the network.

In dimensioning, a rough number of base stations and other network elements are estimated depending on the radio propagation environment and operator's requirements, for instance. Dimensioning takes into account several parameters, such as coverage regions, propagation environment, available spectrum and traffic density, for instance.

One tool used in dimensioning is the calculation of a link budget. In a WCDMA (Wideband Code Division Multiple Access) system, there are some system-specific parameters in calculation of the link budget. One such parameter is interference margin, which has to be larger when more loading of the system is allowed. Loading of the system is estimated by a load factor. The load factor of the j^{th} user can be calculated by

$${L}_{j} = \frac{1}{1 + \frac{W}{{R}_{j} {{v}_{j} ( {E}_{b} / {N}_{0} )}_{j}}} , wherein \\ {L}_{j} = load factor of user j \\ W = WCDMA chip rate {R}_{j} = bit rate of user j \\ {v}_{j} = activity factor of user j at physical layer {E}_{b} / {N}_{0} = signal energy per bit divided by noise spectral density \qquad ( 1 )$$

Formula (1) depicts a situation where there is no interference from other cells, that is, there is only one user.

In CDMA based network systems, noise rise (NR) is measured to control BS usage and keep it at a stable operation point. A stabile and robust network control method is required to track NR changes when new UE connections are added to BS or old UE connections are dropped. Noise rise is connected to the load factor by equation (2).

$$NR = \frac{1}{1 - {\sum }_{j = 1}^{N} {L}_{j}} , wherein \\ N = number of users . \qquad ( 2 )$$

By taking interference from other cells into account, equation (3) is obtained:

$$NR = \frac{1}{1 - ( 1 + i ) {\sum }_{j = 1}^{N} \frac{W}{{R}_{j} {{v}_{j} ( {E}_{b} / {N}_{0} )}_{j}}} , wherein \qquad ( 3 )$$

i is a ratio between the other cell interference and the own cell interference.

By using equation (3), a base station is able to calculate NR change when required (E_{b}/N₀)ⱼ is known for each user j. Signal energy per bit depends on a predefined Quality of Service parameter of the service, bit rate, and receive antenna diversity, for instance.

The estimates for the load factors can be used to determine the number of mobile terminals served by the base stations.

The prior art fails to take into account some important parameters, which may have influence on the load individual users cause to the network. Failing to provide correct estimates for the load of the users may lead to too a low number of users served by the network. Network resources may thus become non-optimally controlled and used.

### SUMMARY

An object of the present invention is thus to provide a method and an apparatus for implementing the method so as to alleviate the above disadvantages. In one aspect of the invention, there is provided a method of controlling radio resources in a radio network, comprising steps of receiving an uplink signal from a user using the network, performing interference cancellation on the received uplink signal, estimating a load factor for the received uplink signal, the load factor indicating the load the uplink signal causes on the network, wherein the load factor is estimated by taking into consideration the interference cancellation performed on the received uplink signal, and allocating radio resources in the network by using the estimated load factor.

In another aspect of the invention, there is provided a radio network, comprising means for receiving an uplink signal from a user using the radio network, means for performing interference cancellation on the received uplink signal, means for estimating a load factor for the received uplink signal, the load factor indicating the load the uplink signal causes on a network element of the radio network, wherein the load factor is estimated by taking into consideration the interference cancellation performed on the received uplink signal, and means for using the estimated load factor when allocating radio resources in the radio network.

In still another aspect of the invention, there is provided a radio network controller, comprising means for controlling at least one base station, means for estimating load of a base station controlled by the controlling means, the estimating means being configured to calculate a load factor for each received uplink signal received from user equipment connected to the base station, the estimating means being further configured to estimate the load factor of the uplink signal by taking into consideration interference cancellation performed on the received uplink signal, the controlling means being configured to allocate radio resources for the base station controlled by the controlling means on the basis of the load factor load factor estimated by the estimating means.

In still another aspect of the invention, there is provided a base station for a radio network, comprising means for receiving an uplink signal from user equipment connected to the base station, means for allocating resources of the base station on the basis of a load estimate of the base station, the load estimate including a load factor, which depicts load, which the uplink signal causes on the base station, the load factor taking into consideration interference cancellation performed on the received uplink signal.

In still another aspect of the invention, there is provided a computer program product encoding a computer program of instructions for executing a computer process in a transmitter for a radio network, the process comprising steps of receiving an uplink signal from a user using the network, performing interference cancellation on the received uplink signal, estimating a load factor for the received uplink signal, the load factor indicating the load the uplink signal causes on the network, wherein the load factor is estimated by taking into consideration the interference cancellation performed on the received uplink signal, and allocating radio resources in the network by using the estimated load factor.

In still another aspect of the invention, there is provided a computer program distribution medium readable by a computer and encoding a computer program of instructions for executing a computer process in a transmitter for a radio network, the process comprising steps of receiving an uplink signal from a user using the network, performing interference cancellation on the received uplink signal, estimating a load factor for the received uplink signal, the load factor indicating the load the uplink signal causes on the network, wherein the load factor is estimated by taking into consideration the interference cancellation performed on the received uplink signal, and allocating radio resources in the network by using the estimated load factor.

The preferred embodiments of the invention are disclosed in the dependent claims.

The invention relates to allocation of resources in a radio network. Especially, the invention relates to allocation of resources in uplink transmission, that is, transmission from mobile stations to base stations of the radio network. The invention is applicable in a radio network using a CDMA (Code Division Multiple Access) access method. Thus, a UMTS (Universal Mobile Telephony System) network applying a WCDMA (Wideband CDMA) access protocol is one example of a radio network according to the invention.

In the invention, load of the network is continuously estimated. Each user and the parameters of the user's connections, such as bit rate or energy of each bit, affect the load of the network elements, such as base stations. Thus, the network needs to estimate load of each uplink connection in the serving network element and also in the neighbouring network elements in order to be able to decide on the resource allocation in the network.

In the invention, interference cancellation is performed on one or more uplink signals. In the solution according to the invention, the interference reducing effect of the interference cancellation is taken into account when estimating the load of individual uplink connections and ultimately of the whole network. For example, if the interference cancellation is able to reduce amount “b” of the interference in a received uplink signal, the network may reduce the load factor calculated for the signal correspondingly by a factor “b” or a factor dependent on “b”.

An advantage of the method and arrangement of the invention is that the load of the network can be estimated so as to better reflect the effective load situation in the network. By reducing the cancelled interference from the load estimates, more traffic may be accepted to the network, which gives more efficient utilization of the network resources.

### DRAWINGS

In the following the invention will be described in greater detail by means of preferred embodiments with reference to the attached drawings, in which

FIG. 1 illustrates the structure of a telecommunication system,

FIG. 2 shows an embodiment of a receiver,

FIG. 3 shows another embodiment of a receiver,

FIG. 4 shows an embodiment of an arrangement according to the invention,

FIG. 5 shows an embodiment of the method according to the invention.

### SOME EMBODIMENTS

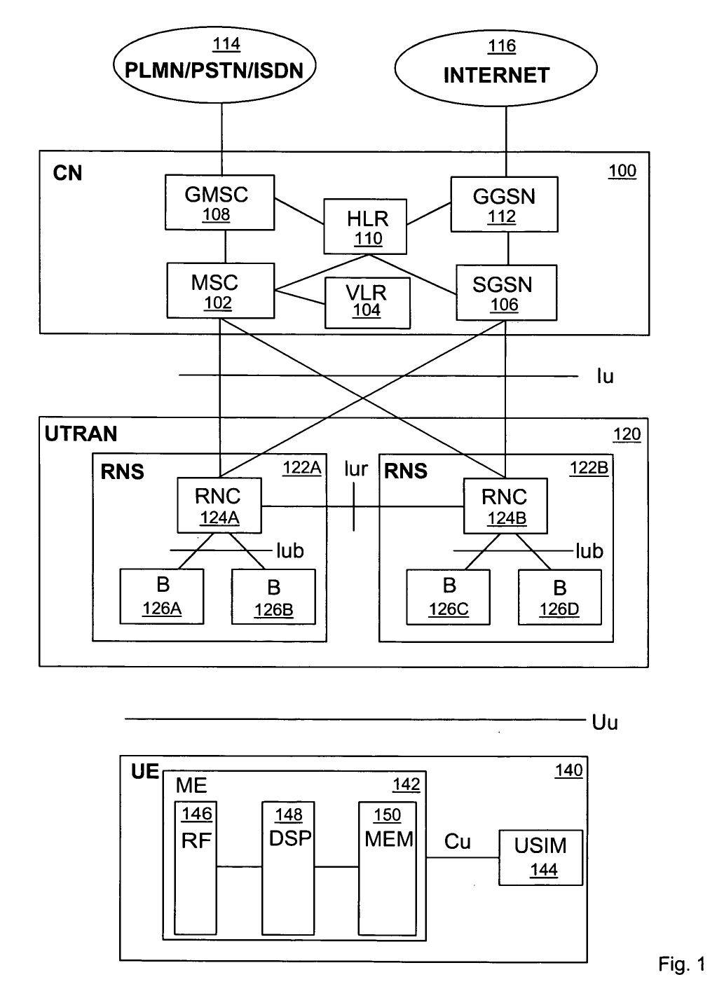

In one embodiment of the invention, the network is a UMTS network applying WCDMA technology. In the following, the structure of the UMTS network is discussed on a general level with reference to FIG. 1.

Structurally, a UMTS network can be divided into a core network (CN) 100, a UMTS terrestrial radio access network (UTRAN) 120, and user equipment (UE) 140. The core network and the UTRAN are part of a network infrastructure of the wireless telecommunications system.

The structure of the core network 100 corresponds to a combined structure for establishing circuit-switched connections and packet-switched connections.

A mobile services switching center (MSC) 102 is the center point of the circuit-switched side of the core network 100. The tasks of the mobile services switching center 102 include switching, paging, user equipment location registration, handover management, collection of subscriber billing information, encryption parameter management, frequency allocation management, and echo cancellation.

Large core networks 100 may have a separate gateway mobile services switching center (GMSC) 108, which takes care of circuit-switched connections between the core network 100 and external networks 114. An external network 114 can be for instance a public land mobile network (PLMN) or a public switched telephone network (PSTN).

A home location register (HLR) 110 contains a permanent subscriber register, which includes, for instance, an international mobile subscriber identity (IMSI), a mobile subscriber ISDN number (MSISDN) and an authentication key. A visitor location register (VLR) 104, which is typically in the same physical device as the MSC, contains roaming information on user equipment 140 in the area of the mobile services switching center 102. The information contents in a visitor location register 104 is almost equal to the information contents in the home location register 110, but in the visitor location register 104 the information is kept only temporarily.

A serving GPRS support node (SGSN) 106 is the center point of the packet-switched side of the core network 100. The main task of the serving GPRS support node 106 is to transmit and receive packets with the user equipment 140 supporting packet-switched traffic. The serving GPRS support node 106 contains subscriber and location information related to the user equipment 140.

A gateway GPRS support node (GGSN) 112 is the packet-switched side counterpart to the gateway mobile services switching center 108 of the circuit-switched side with the exception, however, that the gateway GPRS support node 112 must also be capable of routing traffic from the core network 100 to external packet data networks 116, whereas the gateway mobile services switching center 108 only routes incoming traffic. The external packet data network 116 is represented by the Internet.

The UTRAN may include at least one radio network sub-system (RNS) 122A, 122B, each of which includes at least one radio network controller (RNC) 124A, 124B and at least one Node B 126A to 126D controlled by the RNC. Node B implements a Uu radio interface, through which the user equipment 140 may access the network infrastructure.

The user equipment 140, or the mobile terminal, may include two parts, which are mobile equipment (ME) 142 and a UMTS subscriber identity module (USIM) 144. The mobile equipment also includes radio frequency parts 146 for providing the Uu interface. The user equipment may further include a digital signal processor 148, memory 150, and computer programs for executing computer processes. The user equipment may further include an antenna, a user interface, and a battery. The USIM comprises user-related information and information related to information security, such as an encryption algorithm.

In a DS-CDMA (Direct Sequence CDMA) system, user data is multiplied with a spreading code, which is a sequence of code bits called chips. In the receiver, the same spreading code is used to multiply (or correlated to) the received signal so that the originally transmitted user data can be recovered. Due to multiplying with the spreading code, that is, despreading, the amplitude of the desired signal is multifold to other signals, which is called processing gain. Due to processing gain, the 5 MHz carrier frequencies can be reused in close distances.

Both the base stations and the mobile stations typically use a correlation receiver for detecting the signal. Due to multipath propagation, it is desirable to use multiple correlation receivers so as to recover all the energy from different propagation paths. Such a receiver including multiple correlation receivers (fingers) is called a RAKE receiver. The basic principle of a RAKE receiver is following: the most significant delay components are identified from the user signal, and fingers of the receiver are allocated to those components. Each correlation receiver tracks fast-changing phase and amplitude values and compensates for them. Finally, all demodulated and phase-adjusted symbols received from all fingers are combined and forwarded to a decoder for further processing.

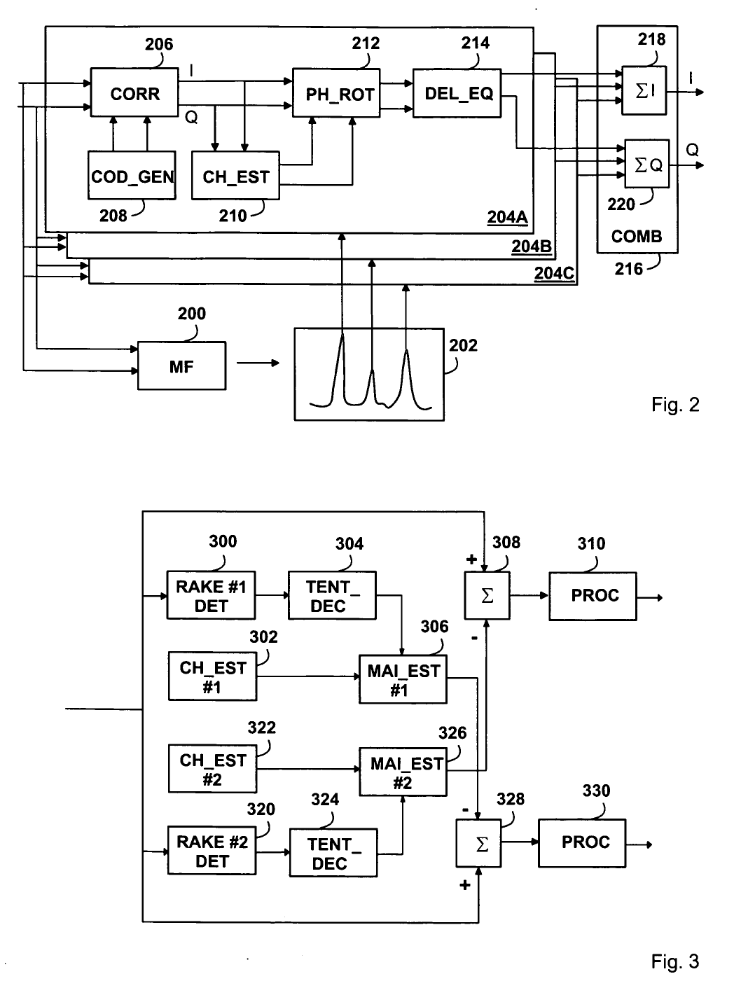

FIG. 2 highlights the principle of a RAKE receiver. The receiver has a matched filter 200, which tracks the multipath components in the signal shown by the delay profile 202. The three peaks in the delay profile 202 are respectively allocated to the three fingers 204A, 204B and 204C of the receiver.

Input samples are received in the form of I- and Q-branches. The code generator 208 and the correlator 206 despread and integrate the data into user data symbols. The channel estimator 210 can estimate the channel state by using pilot symbols. The effect of the channel state can be removed by the phase rotator 212. The equalizer 214 equalizes the delays of the RAKE fingers to each other. The combiner 216 includes summing units 218 and 220 for summing the channel-compensated symbols from all fingers to provide multipath diversity against fading for the receiver.

In a CDMA system, wherein the correlation principle is applied in matched filter and/or correlators, multiple access interference (MAI) is generated due to that the spreading codes are not completely orthogonal. Because MAI is generated by other users of the network, it can be taken into consideration in the receiver. Algorithms can be categorized into centralized multi-user detection or decentralized single-user algorithms. The centralized algorithms perform multi-user detection simultaneously and are practical in base stations. The single user algorithms detect the symbols of a single user in a multi-user environment and are applicable both in a base station and in a mobile station.

FIG. 3 shows on a general level a receiver applying parallel interference cancellation (PIC). The receiver of FIG. 3 shows one interference cancellation stage for two users. In detection units 300 and 320, the signals of users #1 and #2 are detected and tentative decisions of the symbols are made in units 304 and 324, respectively. The channel estimates of channels used by user #1 and provided by unit 302 are used in combination of the tentative symbol estimates of user #1 to estimate the MAI of user #1. This estimate is subtracted from the total input signal in summing means 328. Correspondingly, the signal of user #2 is considered as interference from the point of view of user #1. The estimate of the user #2 signal is reduced from the total received signal in the summing unit 308 so as to alleviate detection of the user #1 signal.

The summing means 328 (and 308 respectively) may be followed by one or more additional interference cancellation stages, which are not illustrated in FIG. 3. FIG. 3 shows a processing unit 330 following the summing unit, which processing unit may be configured to carry out tasks such as deinterleaving, decoding of the signal and making the final symbol estimates.

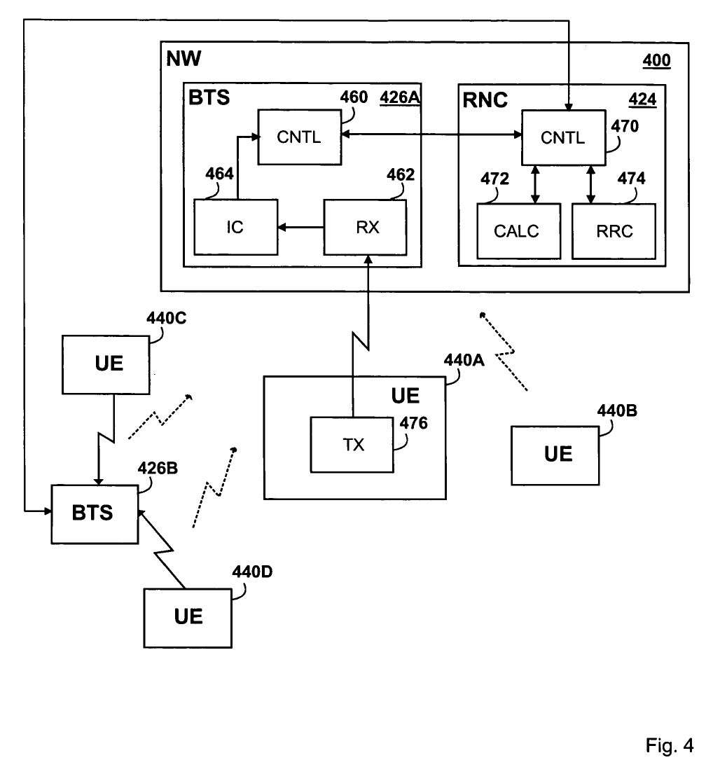

FIG. 4 also shows one additional embodiment of an arrangement according to the invention. The network 400 is a mobile network having a radio network controller 424 and a base station (Node B) 426A controlled by the radio network controller.

The base station 426A serves user equipment 440A. The uplink signal transmitted by the transmitting unit 476 of user equipment is received in the receiving unit 462 of the base station. The base station performs interference cancellation in IC unit 464. The magnitude or effectiveness of interference cancellation is characterized by factor beta b. The control unit 460 of the base station 426A is adapted to communicate with control unit 470 of the radio network controller 424. The information between the control units may include power levels of the incoming uplink signals and noise level experienced by the base station, for instance.

The embodiment of FIG. 4 shows a calculating unit 472 for calculating the load factors of the individual connections. The radio network controller 424 may also include a radio resource controller (RRC) 474 for controlling radio resources. In the embodiment of FIG. 4, the RRC may compare the load level of the base station 426A to a predetermined threshold value set for the load level. If the load of the base station allows, new connections may be added to the base station. The cumulative load index is also updated with regard to terminating connections so that the load terminating connections is subtracted from the cumulative load index.

FIG. 4 also shows base station 426B, which is also controlled by the radio network controller 424. The radio network controller 424 is thus aware of the connections and load situations in both base stations 426A and 426B. That is, the radio network controller 424 knows the power levels of the uplink connections from the user equipment 440C and 440D served by the base station 426B. The base station 426A sees the power of the user equipment 440C and 440D as interference power and the network controller 424 can use it when calculating parameter “interference in the other cell” of factor i in formula (3). The base station 426A also serves user equipment 440B, which can be used to calculate parameter “interference in the own cell” of factor i in formula (3).

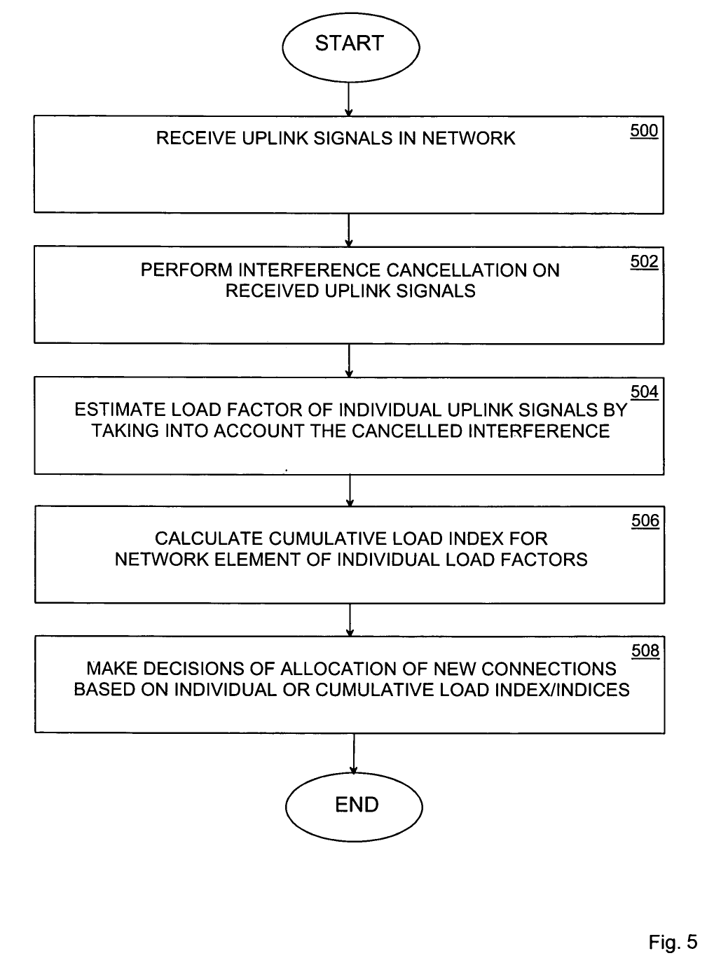

FIG. 5 shows one embodiment of a method according to the invention. In the method, there are mobile stations in a two-directional radio connection with the network. The network includes network elements, such as base stations or Node Bs for implementing the radio connection towards the mobile stations. Step 500 discloses reception of the uplink signals.

In 502, the network performs interference cancellation on the uplink signals. The interference cancellation method can be based on parallel interference cancellation, for instance. The invention is not, however, restricted to the interference cancellation method used.

In 504, the load (load factor), which an individual connection causes to a base station, is estimated. In one embodiment, the load estimation is done in a radio network controller controlling the base station. In another embodiment, the base station (Node B) may estimate the load of a cell itself. That may especially be the case when a packet scheduler is located in a Node B, in which case the Node B can directly use it for estimating load of a cell.

The interference cancellation methods can be given a so-called beta-value (b), which depicts how much of the interference is cancelled by the interference cancellation method. The beta-value or interference cancellation factor thus characterizes the effectiveness of the interference cancellation performed in the network. The beta-value can be estimated by simulations or by measuring the interference cancellation process in a large number of connections. The beta-value used in the invention can be a constant value, such as “0.2” indicating that 20% of the interference can typically be cancelled by the interference method applied. In another embodiment, contrary to using a constant value, the beta-value may be delivered connection-specifically from a base station to the radio station controller. In one embodiment, both BS and RNC have a table including possible beta values. The table may include values such as [0; 0.1; 0.2; 0.3; . . . 1.0]. The index value 3, which may be signalled from Node B to RNC, thus refers to the beta-value “0.2” if the index “1” refers to the first position in the table having value (0).

In 504, the load factor can be estimated by using formula (4)

$${L}_{j}^{′} = {L}_{j} \frac{1 + i - b}{1 + i} , where \qquad ( 4 )$$

L′ⱼ is the corrected load factor of the j^{th} user

Lⱼ is the calculated load factor without taking interference cancellation into account

b is the beta value of the interference cancellation and is in range [0, 1]

i is the ratio of interference in other cells to interference in own cell.

In calculating the value of i, the sum uplink signal power of all users served by a base station BS1 needs to be calculated. Then, the sum signal powers of users served by neighbouring base stations (e.g. BS2, BS3 and BS4) needs to be calculated to obtain “interference in other cells”.

In 506, the cumulative load index for a certain base station is calculated by applying formula (4) to all users served by a base station. Thereby, a cumulative load index for a network element is obtained.

In 508, the network makes decisions whether a new uplink connection may be allocated to a certain base station considering the load of the base station. The individual or cumulative load index/indices for a network element is known and it is compared to a predetermined threshold value determining how much load can be allowed for a certain network element.

The invention, including different means for carrying out functions in a network, a network element, a receiver, a radio network controller, a base station or Node B may be implemented by a computer program or software, which is loadable and executable in a processor.

The computer program may be stored on a computer program distribution medium readable by a computer or a processor. The computer program medium may be, for example but not limited to, an electric, magnetic, optical, infrared or semiconductor system, device or transmission medium. The medium may be a computer readable medium, a program storage medium, a record medium, a computer readable memory, a random access memory, an erasable programmable read-only memory, a computer readable software distribution package, a computer readable signal, a computer readable telecommunications signal, and a computer readable compressed software package.

Alternatively, the invention may be implemented by ASIC (Application Specific Integrated Circuit), separate logic components or by some corresponding way.

It will be obvious to a person skilled in the art that, as the technology advances, the inventive concept can be implemented in various ways. The invention and its embodiments are not limited to the examples described above but may vary within the scope of the claims.

1. A method of controlling radio resources in a radio network, comprising:
receiving an uplink signal from a user using the network;
performing interference cancellation to the uplink signal;
estimating a load factor on the uplink signal, the load factor indicating a load the uplink signal causes on the network, wherein the load factor is estimated by taking into consideration the interference cancellation performed on the uplink signal; and
allocating radio resources in the network by using the load factor.

2. A method according to claim 1, further comprising:
calculating a cumulative load estimate as a sum of load factors of users of the network; and
monitoring continuously that the cumulative load estimate remains under a predetermined threshold value.

3. A method, according to claim 1, wherein
the load factor is estimated by multiplying the load factor calculated without interference cancellation by factor (1+i−b)/(1+i), wherein i is a ratio of interference caused by another coverage area of the network to interference of an estimator's own coverage area of the network and b is a parameter representing an ability of the network to perform interference cancellation.

4. A method according to claim 1, wherein
the load factor depends on at least one user-specific parameter of: bit rate, activity, chip rate, signal energy per bit, or ratio between interference in other cells to interference in an estimater's own cell.

5. A radio network, comprising:
receiving means for receiving an uplink signal from a user using the radio network;
interference cancellation means for performing interference cancellation on the uplink signal;
estimating means for estimating a load factor for the uplink signal, the load factor indicating a load the uplink signal causes on a network element of the radio network, wherein the load factor is estimated by taking into consideration an interference cancellation performed on the uplink signal by the interference cancellation means; and
using means for using the load factor when allocating radio resources in the radio network.

6. A radio network according to claim 5, further comprising:
calculating means for calculating a cumulative load estimate as a sum of load factors of users of the network; and
monitoring means for monitoring continuously that the cumulative load estimate of a radio network element remains under a predetermined threshold value.

7. A radio network according to claim 5, wherein the estimating means is configured to:
calculate the load factor by omitting an effect of the interference cancellation; and
multiply the load factor obtained by omitting the effect of interference cancellation by factor (1+i−b)/(1+i), wherein i is a ratio between interference caused by another coverage area of the radio network to interference of an estimator's coverage area of the network element, and b is a parameter representing an ability of the network element to perform interference cancellation on the uplink signal.

8. A radio network according to claim 5, wherein an interference cancellation factor characterizes an effectiveness of the interference cancellation means to perform interference cancellation.

9. A radio network according to claim 8, wherein the interference cancellation factor is a constant.

10. A radio network according to claim 8, wherein the radio network includes:
a memory for storing a set of predetermined values for the interference cancellation factor, a value of the set of predetermined values being associated with an index indicating a storage position of the value in the memory; and
means for selecting an interference cancellation factor from the memory based on the index.

11. A radio network according to claim 5, wherein
the load factor depends on at least one user-specific parameter of: bit rate, activity, chip rate, signal energy per bit, or ratio between interference in other cells to interference in an estimator's own cell.

12. A radio network controller, comprising:
controlling means for controlling at least one base station;
estimating means for estimating a load of a base station controlled by the controlling means, the estimating means being configured to calculate a load factor for each received uplink signal received from user equipment connected to the at least one base station, the estimating means being further configured to estimate the load factor of the uplink signal by taking into consideration interference cancellation performed on the received uplink signal, the controlling means being configured to allocate radio resources for the base station controlled by the controlling means based on the load factor estimated by the estimating means.

13. A base station for a radio network, comprising:
receiving means for receiving an uplink signal from user equipment connected to the base station;
allocating means for allocating resources of the base station based on a load estimate of the base station, the load estimate including a load factor, which depicts load that the uplink signal causes on the base station, the load factor taking into consideration interference cancellation performed on the uplink signal.

14. A computer program product encoding a computer program of instructions for executing a computer process in a transmitter for a radio network, the process comprising:
receiving an uplink signal from a user using the network;
performing interference cancellation on the uplink signal;
estimating a load factor for the uplink signal, the load factor indicating a load the uplink signal causes on the network, wherein the load factor is estimated by taking into consideration interference cancellation performed on the uplink signal;
allocating radio resources in the network by using the load factor.

15. A computer program distribution medium readable by a computer and encoding a computer program of instructions for executing a computer process in a transmitter for a radio network, the process comprising:
receiving an uplink signal from a user using the network;
performing interference cancellation on the uplink signal;
estimating a load factor for the uplink signal, the load factor indicating a load the uplink signal causes on the network, wherein the load factor is estimated by taking into consideration interference cancellation performed on the uplink signal;
allocating radio resources in the network by using the load factor.

16. The radio network controller of claim 12, wherein
the load factor is estimated by multiplying the load factor calculated without interference cancellation by factor (1+i−b)/(1+i), wherein i is a ratio of interference caused by another coverage area of a network to interference of an estimator's own coverage area of the network and b is a parameter representing an ability of the network to perform interference cancellation.

17. The base station of claim 13, wherein
the load factor is estimated by multiplying the load factor calculated without interference cancellation by factor (1+i−b)/(1+i), wherein i is a ratio of interference caused by another coverage area of a network to interference of an estimator's own coverage area of the network and b is a parameter representing an ability of the network to perform interference cancellation.

18. The computer program product of claim 14, wherein
the load factor is estimated by multiplying the load factor calculated without interference cancellation by factor (1+i−b)/(1+i), wherein i is a ratio of interference caused by another coverage area of the network to interference of an estimator's own coverage area of the network and b is a parameter representing an ability of the network to perform interference cancellation.

19. The computer program distribution medium of claim 15, wherein
the load factor is estimated by multiplying the load factor calculated without interference cancellation by factor (1+i−b)/(1+i), wherein i is a ratio of interference caused by another coverage area of the network to interference of an estimator's own coverage area of the network and b is a parameter representing an ability of the network to perform interference cancellation.

20. The radio network controller of claim 12, further comprising:
calculating means for calculating a cumulative load estimate as a sum of load factors of the users of the network; and
monitoring means for monitoring continuously that the cumulative load estimate remains under a predetermined threshold value.
